(19) United States
(12) Patent Application Publication
(10) Pub. No.: US 2020/0283708 A1
(43) Pub. Date: Sep. 10, 2020

(54) A SOY WHEY-DERIVED BEVERAGE

(71) Applicant: NATIONAL UNIVERSITY OF SINGAPORE, Singapore (SG)

(72) Inventors: Shao Quan LIU, Singapore (SG); Jian Yong CHUA, Singapore (SG)

(21) Appl. No.: 16/606,658

(22) PCT Filed: Apr. 18, 2018
(86) PCT No.: PCT/SG2018/050193

§ 371 Date: Oct. 18, 2019

(30) Foreign Application Priority Data
Apr. 19, 2017 (SG) 10201703194V

(51) Int. Cl. C12G 3/026; A23L 2/46; C12G 3/025; A23L 2/38; C12H 1/18; A23C 11/10

(52) U.S. Cl. CPC C12G 3/026; A23L 2/46; C12G 3/025; A23V 2002/00; C12H 1/18; A23C 11/106; A23L 2/382

(57) ABSTRACT

There is provided a soy whey-derived beverage comprising 12-30 mg/L free soy isoflavones. There is also provided a method for forming the soy whey-derived beverage comprising: providing soy whey; adding a microorganism to the soy whey; and fermenting the soy whey at a predetermined temperature and period of time. In various embodiments, the beverage has an alcohol content of <0.5% by volume or >0.5% by volume or a total isoflavone content of >20 mg/L. In a preferred embodiment, the microorganism is a yeast and/or the beverage is preferably wine.

### TECHNICAL FIELD

The present invention relates to a soy whey-derived beverage and a method of forming the same. In particular, the soy whey-derived beverage may be a fermented beverage.

### BACKGROUND

Soy whey is a liquid waste stream generated from soy beancurd manufacturing. Soy whey itself is a nutritive medium. Due to the high biological oxygen demand (BOD) and chemical oxygen demand (COD) in view of the nutrient content comprising mainly protein and soluble sugars, direct disposal of the soy whey into a drainage system will result in environmental pollution. Hence, it is necessary for soy whey to be pre-treated before it is discharged into the drainage system. Current soy whey treating methods still result in generation of a considerable amount of waste at the end of the methods.

### SUMMARY OF THE INVENTION

The present invention seeks to address these problems, and/or provides a soy whey-derived beverage, as well as an improved method for biotransforming soy whey into a suitable beverage without generating any waste stream. The beverage according to the present invention may have health benefits in view of the presence of free isoflavones within the beverage. In particular, free isoflavones are known to confer health benefits to consumers in view of their antioxidant properties and in reducing the risk of cancer and cardiovascular diseases.

According to a first aspect, the present invention provides a soy whey-derived beverage comprising ≥10 mg/L. In particular, the soy whey-derived beverage may comprise 12-30 mg/L free soy isoflavones. Further, the beverage may have a total soy isoflavone content of ≥20 mg/L. In particular, the soy whey-derived beverage may have a total soy isoflavone content of 25-55 mg/mL.

The beverage may be any suitable beverage. According to a particular aspect, the beverage may be a fermented beverage.

The beverage may be an alcoholic or non-alcoholic beverage. In particular, if the beverage is a non-alcoholic beverage, the beverage may have an alcohol content of <0.5% by volume. If the beverage is an alcoholic beverage, the beverage may have an alcohol content of ≥0.5% by volume. In particular, the beverage may have an alcohol content of 5-40% by volume. For example, the alcohol content may be 7-38%, 10-35%, 12-30%, 15-28%, 17-25%, 20-22%. Even more in particular, the alcohol content may be 5-15%.

According to a particular aspect, the beverage may be an alcoholic beverage. In particular, the beverage may be an alcoholic beverage such as, but not limited to, a soy whey-derived wine.

The beverage may have any suitable pH. For example, the pH of the beverage may be 2-6. In particular, the pH may be 2.5-5.5, 3-5, 3.5-4.5, 3.75-4.0. Even more in particular, the pH may be about 3.5-5.

The beverage may have a suitable Brix. For example, the Brix of the beverage may be 3-20° Bx. In particular, the Brix may be 5-18° Bx, 6-15° Bx, 7-12° Bx, 8-10° Bx, 9-9.5° Bx. Even more in particular, the Brix may be about 5-15° Bx.

The beverage may have a suitable ester content. For example, the ester content of the beverage may be about 5-10 mg/L.

According to a second aspect of the present invention, there is provided a method of forming a soy whey-derived beverage described above, the method comprising:
providing soy whey;
adding a microorganism to the soy whey; and
fermenting the soy whey at a pre-determined temperature for a pre-determined period of time to form the beverage.

The soy whey may be any suitable soy whey for the purposes of the present invention.

The microorganism may be any suitable microorganism. For example, the microorganism may be yeast, Zymomonas mobilis, lactic acid bacteria or acetic acid bacteria.

According to a particular aspect, the microorganism may be yeast. The yeast may be any suitable yeast for the purposes of the present invention. For example, the yeast may be Saccharomyces yeast, non-Saccharomyces yeast, or a combination thereof. In particular, the yeast may be Saccharomyces (S.) cerevisiae, Torulaspora (T.) delbrueckii, Kluyveromyces (K.) thermotolerans, Metschnikowia (M.) puicherrima, Pichia (P.) kluyveri, Williopsis (W.) saturnus, or a combination thereof.

The pre-determined period of time may be any suitable period of time for the purposes of the present invention. According to a particular aspect, the pre-determined period of time may be 2-21 days.

The pre-determined temperature may be any suitable temperature for the purposes of the present invention. According to a particular aspect, the pre-determined temperature may be 13-35° C.

According to a particular aspect, the method may further comprise adjusting the pH of the soy whey prior to the adding a microorganism to the soy whey. For example, the pH may be adjusted to a pH of 3-5.

According to a particular aspect, the method may further comprise adding sugars to the soy whey prior to the adding a microorganism to the soy whey. The sugars added may be any suitable sugars for the purposes of the present invention.

According to a particular aspect, the method may further comprise heating the soy whey prior to the adding a microorganism to the soy whey.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows growth of four Saccharomyces cerevisiae strains during soy whey fermentation;

FIG. 2(a) shows pH change and FIG. 2(b) shows soluble solid content change during soy whey fermentation;

FIG. 3(a) shows changes in isoflavone glycoside (daidzin) and free isoflavone (daidzein) concentration, FIG. 3(b) shows changes in isoflavone glycoside (glycitin) and free isoflavone (glycitein) concentration, FIG. 3(c) shows changes in isoflavone glycoside (genistin) and free isoflavone (genistein) concentration and FIG. 3(d) shows changes in antioxidant capacity of the soy whey and soy whey wine after fermentation;

FIG. 4(a) shows changes in the ethanol content and FIG. 4(b) shows changes in the isoamyl alcohol, 1-hexanol and 2-phenylethanol content, in the soy whey before and after fermentation;

FIG. 5(a) shows changes in the content of Ethyl acetate, isoamyl acetate, hexyl acetate and 2-phenylethyl acetate and FIG. 5(b) shows changes in the content of ethyl hexanoate and ethyl octanoate, in the soy whey before and after fermentation;

FIG. 6 shows the changes in the hexanal (aldehyde) content before and after fermentation;

FIG. 7 shows the changes in 2-pentylfuran content before and after fermentation;

FIG. 8 shows the growth of the five non-Saccharomyces strains during soy whey fermentation;

FIG. 9(a) shows pH change and FIG. 9(b) shows soluble solid content change during soy whey fermentation;

FIG. 10(a) shows changes in the isobutanol and phenylethanol content, FIG. 10(b) shows changes in the isoamyl alcohol content, FIG. 10(c) shows the changes in the 1-pentanol, 1-hexanol and 1-octen-3-ol content, in the soy whey before and after fermentation;

FIG. 11(a) shows changes in the acetic acid and hexanoic acid content, FIG. 11(b) shows changes in the content of isobutyric acid and 3-methylbutanoic acid and FIG. 11(c) shows changes in the content of octanoic acid, of the soy whey before and after fermentation;

FIG. 12(a) shows changes in the content of Ethyl hexanoate, ethyl decanoate, FIG. 12(b) shows changes in the content of ethyl octanoate, ethyl 9-decenoate and FIG. 12(c) shows changes in the content of 2-phenylethyl acetate, ethyl heptanoate and ethyl nonanoate, of the soy whey before and after fermentation;

FIG. 13(a) shows changes in the content of hexanal, FIG. 13(b) shows changes in the content of octanal and 2-decenal, FIG. 13(c) shows changes in the content of 2-pentenal, 2-hexenal and 2-heptenal, of the soy whey before and after fermentation;

FIG. 14 shows changes to the phytate concentration (expressed as phytic acid-phosphate) in the soy whey before and after fermentation;

FIG. 15 shows growth of Torulaspora delbrueckii Biodiva during soy whey fermentation;

FIG. 16(a) shows pH change and FIG. 16(b) shows soluble solid content change during soy whey fermentation;

FIG. 17 shows changes to the sucrose content during fermentation;

FIG. 18(a) shows changes in the malic acid content, FIG. 18(b) shows changes in the content of alpha-ketoglutaric acid, FIG. 18(c) shows changes in the content of succinic acid and FIG. 18(d) shows changes in the content of pyruvic acid, of the soy whey during fermentation;

FIG. 19 shows the glycerol content in the soy whey-derived alcoholic beverage;

FIG. 20 shows the ethanol content in the soy whey-derived alcoholic beverage;

FIG. 21 shows changes to the soluble protein content in the soy whey during fermentation;

FIG. 22(a) shows changes daidzin concentration, FIG. 22(b) shows changes in the daidzein concentration, FIG. 22(c) shows changes in genistin concentration, FIG. 22(d) shows changes in genistein concentration, of the soy whey during fermentation and FIG. 22(e) shows changes in antioxidant capacity of the soy whey wine after fermentation;

FIG. 23 shows the growth of Torulaspora delbreuckii Biodiva in the soy whey at different fermentation temperatures;

FIG. 24(a) shows pH change and FIG. 24(b) shows soluble solid content change during soy whey fermentation;

FIG. 25 shows the growth of Torulaspora delbreuckii Biodiva in the soy whey at different sugar concentrations; and

FIG. 26(a) shows pH change and FIG. 26(b) shows soluble solid content change during soy whey fermentation.

### DETAILED DESCRIPTION

As explained above, there is a need for processing soy whey which can otherwise be environmentally damaging. The present invention relates to a soy whey-derived beverage which fully utilises soy whey, which is a waste stream of soybean manufacturing. The soy whey-derived beverage may be formed in an environmentally friendly manner and is also a simple method, making scale up of the method possible. In particular, the method of forming the soy whey-derived beverage of the present invention fully utilises soy whey and achieves practically zero waste.

In general terms, the invention relates to a soy whey-derived beverage and a method of forming the same. The soy whey-derived beverage may have health benefits as the beverage may comprise isoflavones in free form which are bioavailable. The bioavailability of free isoflavones in a human is known to impart good health benefits such as antioxidance and reduction of risks of diseases such as cancer and cardiovascular diseases.

According to a first aspect, the present invention provides a soy whey-derived beverage comprising free soy isoflavones. The free isoflavones may also be referred to as isoflavone aglycone. The soy whey-derived beverage may comprise 10 mg/L free soy isoflavones. In particular, the soy whey-derived beverage may comprise 10-35 mg/L, 12-30 mg/L, 15-28 mg/L, 17-25 mg/L, 20-23 mg/L, 21-22 mg/L free soy isoflavones. Even more in particular, the beverage comprises 12-30 mg/L free soy isoflavones.

For the purposes of the present invention, free soy isoflavones is defined as a plant-based bioactive phytoestrogenic compound without a sugar molecule attached to it. The free soy isoflavones may include, but is not limited to, daidzein, glycitein and genistein. The free soy isoflavones comprised in the beverage are beneficial as they enhance the absorption of the isoflavones in the gastrointestinal tract of the consumer of the beverage.

According to a particular aspect, the beverage may have a total soy isoflavone content of ≥20 mg/L. The total soy isoflavones measures the total amount of isoflavones consisting of free isoflavones and bound isoflavones (isoflavone glycoside) in the beverage. In particular, the total soy isoflavone content may be 25-55 mg/mL, 27-52 mg/L, 30-50 mg/L, 32-48 mg/L, 25-45 mg/L, 30-40 mg/L, 32-38 mg/L, 33-35 mg/L. Even more in particular, the beverage comprises 27-50 mg/L total soy isoflavones.

The beverage may be any suitable soy whey-derived beverage. According to a particular aspect, the beverage may be a fermented beverage. A fermented beverage may be defined as a beverage which has undergone fermentation.

The beverage may be an alcoholic or non-alcoholic beverage. According to a particular aspect, the beverage may be a non-alcoholic beverage. In particular, the beverage may have an alcohol content of <0.5% by volume. The beverage may be any suitable non-alcoholic beverage. Examples of a non-alcoholic beverage may include, but is not limited to, soy whey probiotic beverage, soy whey vinegar beverage and other non-alcoholic fermented beverage.

According to another particular aspect, the beverage may be an alcoholic beverage. For the purposes of the present invention, an alcoholic beverage is defined as a beverage which comprises an alcohol. The alcohol may include ethanol. In particular, the beverage may have an alcohol content of ≥0.5% by volume.

In particular, the beverage may have an alcohol content of 5-40% by volume. For example, the alcohol content may be 7-38%, 10-35%, 12-30%, 15-28%, 17-25%, 20-22%. Even more in particular, the alcohol content may be 5-15%.

According to a particular aspect, the beverage may be any suitable alcoholic beverage. Examples of an alcoholic beverage may include, but is not limited to, wine, ciders, beers and spirits. In particular, the beverage may be a soy whey-derived wine.

The beverage may have a suitable pH. For example, the pH of the beverage may be 2-6. In particular, the pH may be 2.5-5.5, 3-5, 3.5-4.5, 3.75-4.0. Even more in particular, the pH may be about 3.5-5.

The beverage may have a suitable Brix or its specific gravity equivalent. Brix is a measure of the amount of sugars in the beverage. For example, 1° Bx refers to 1 g of sucrose in 100 g of the beverage. Accordingly, the higher the Brix, the higher the amount of sugars in the beverage which in turn may relate to a higher alcohol content in the beverage.

The Brix of the beverage may be 3-20° Bx. For the purposes of the present invention, reference to Brix of the alcoholic beverage refers to the measure of the Brix of the soy-whey comprised in the beverage. In particular, the Brix of the beverage may be 5-18° Bx, 6-15° Bx, 7-12° Bx, 8-10° Bx, 9-9.5° Bx. Even more in particular, the Brix may be about 5-15° Bx.

According to a particular aspect, the beverage may have a suitable ester content. For example, the ester content of the beverage may be 5-10 mg/L. The presence of esters in the beverage show that the beverage has undergone fermentation. In particular, the ester comprised in the beverage may impart a fruity and floral characteristic to the beverage. This may be advantageous as the esters may help to mask the beany and/or grassy odour which may have been originally present in the soy whey.

The esters comprised in the beverage may be any suitable ester. For example, the ester may be, but not limited to, ethyl esters, acetate esters, or a combination thereof. In particular, the esters may be, but not limited to, ethyl acetate, isoamyl acetate, hexyl acetate, 2-phenylethyl acetate, ethyl hexanoate, ethyl octanoate, or a combination thereof.

According to a second aspect of the present invention, there is provided a method of forming a soy whey-derived beverage described above, the method comprising:
providing soy whey;
adding a microorganism to the soy whey; and
fermenting the soy whey at a pre-determined temperature for a pre-determined period of time to form the beverage.

The soy whey may be any suitable soy whey for the purposes of the present invention.

The soy whey may undergo treatment before the adding a microorganism to the soy whey. According to a particular aspect, the method may further comprise adjusting the pH of the soy whey prior to the adding. The adjusting the pH enables the microorganism to grow in the soy whey. For example, the pH may be adjusted to a pH of 3-5. The adjusting the pH may be by any suitable method. For example, the adjusting may comprise adding a suitable acid. The acid used for the adjusting must be an acid which is suitable for being consumed. In particular, the acid may be, but not limited to, malic acid, citric acid, lactic acid, tartaric acid, gluconic acid, succinic acid, or a combination thereof.

According to a particular aspect, the method may further comprise adding sugars to the soy whey prior to the adding a microorganism to the soy whey. The addition of the sugars may be for increasing carbohydrate content in the soy whey. The sugars added may be any suitable sugars for the purposes of the present invention. For example, the sugars added may comprise, but is not limited to, glucose, sucrose, fructose, or a combination thereof. The adding the sugars may be to adjust the Brix of the soy whey. In particular, the Brix of the soy whey may be adjusted to 3-30° Bx. Even more in particular, the Brix of the soy whey may be adjusted to 10-15° Bx.

According to a particular aspect, the method may further comprise heating the soy whey prior to adding a microorganism to the soy whey. The heating may comprise mild pasteurization of the soy whey. The heating may extend the shelf life of the soy whey prior to the fermenting and may also reduce the risk of contamination during the fermenting. The heating may be carried out under suitable conditions. For example, the heating may be carried out at a temperature of about 40-140° C. In particular, the temperature may be about 60-80° C.

The heating may be carried out for a suitable period of time. For example, the heating may be for 2 seconds-60 minutes. In particular, the heating may be for about 10-30 minutes. Even more in particular, the heating may be for about 20 minutes.

The microorganism may be any suitable microorganism. For example, the microorganism may be yeast, Zymomonas mobilis, lactic acid bacteria or acetic acid bacteria.

In particular, the microorganism may be yeast. The yeast may be any suitable yeast for the purposes of the present invention. The yeast may be Saccharomyces yeast, non-Saccharomyces yeast, or a combination thereof.

According to a particular aspect, the microorganism may be Saccharomyces yeast. Examples of Saccharomyces yeast include, but are not limited to, Saccharomyces (S.) cerevisiae, S. pastorianus, S. boulardii.

According to another particular aspect, the microorganism may be non-Saccharomyces yeast. Examples of non-Saccharomyces yeast include, but are not limited to, Torulaspora (T.) delbrueckii, Kluyveromyces (K.) thermotolerans, Metschnikowia (M.) puicherrima, Pichia (P.) kluyveri, Williopsis (W.) saturnus, or a combination thereof.

The adding a microorganism may comprise adding a suitable amount of microorganism. For example, when the microorganism is yeast, the amount of yeast added may be 1-9 log CFU/mL. In particular, the amount may be 5-7 log CFU/mL.

The fermenting may be carried out under suitable conditions. For example, the fermenting may be at a pre-determined temperature for a pre-determined period of time. The pre-determined period of time may be any suitable period of time for the purposes of the present invention. According to a particular aspect, the pre-determined period of time may be 2-21 days. In particular, the pre-determined period of time may be about 7-14 days. Even more in particular, the pre-determined period of time may be about 10 days.

The pre-determined temperature may be any suitable temperature for the purposes of the present invention. According to a particular aspect, the pre-determined temperature may be 13-35° C. In particular, the pre-determined temperature may be 15-25° C. Even more in particular, the pre-determined temperature may be 20° C. The temperature may be changed at any point during the fermenting.

Whilst the foregoing description has described exemplary embodiments, it will be understood by those skilled in the technology concerned that many variations may be made without departing from the present invention.

Having now generally described the invention, the same will be more readily understood through reference to the following examples which are provided by way of illustration, and are not intended to be limiting.

### EXAMPLE

### Soybean Curd Production and Soy Whey Collection

For all the examples, the soy whey was generated through small scale production of soybean curd. In particular, soymilk was generated by blending 100 g of soybeans (from Canada) obtained from a supermarket with 800 mL of water for 16 hours. After that, the soaked beans were drained and blended with deionized (DI) water using a blender (Model MX-J210GN, Panasonic, Osaka, Japan) in a 1:8 dry weight to volume ratio to obtain a slurry. The slurry was then filtered through a cheese cloth to obtain soymilk. The residue (okara) was rinsed with deionized water in a 1:2 dry weight to volume ratio. The soymilk was boiled for 5 minutes and cooled to 87° C. prior to the addition of 2% (w/w with respect to the dry weight of the soybean) commercial calcium sulfate (Home Brew Ohio, Sandusky, USA) suspended in deionized water. The mixture was stirred to ensure proper mixing of the coagulant with the soymilk before it was allowed to stand for 15 minutes. The calcium ions served as bridging ions to facilitate the cross-linking between soy proteins to form the gel (soybean curd). The coagulated soymilk (tofu) was transferred onto a meshed mold overlaid with a cheese cloth. The tofu was pressed thrice for 5 minutes each at maximum pressure using a manual press and the tofu whey was collected below the meshed mold. The pH of the tofu whey (initial pH of 5.78) was first adjusted to pH 4.0 using 1 M D-/L-malic acid. The soluble solids content (° Brix; an initial value of 2.55) was then adjusted to 15° Brix using commercial sucrose. The pre-treated tofu whey was pasteurized at 60° C. for 20 minutes and the effectiveness of the pasteurization was verified via plate counting.

### Fermentation

Fermentations were conducted in 500-mL Erlenmeyer flasks containing 300 mL of pasteurized soy whey. Each flask was inoculated with 1% (v/v) of each pre-culture of yeast. The fermentation was carried out statically at 20° C. for 10 days and samples were withdrawn periodically for analysis. Yeast cell count was determined by spread plating on potato dextrose agar (PDA; Oxoid, Hampshire, United Kingdom).

### Analysis Methodology

The pH and ° Brix values were measured using a pH meter (827 pH Lab, Metrohm, Herisau, Switzerland) and a refractometer (RX-5000a, ATAGO, Tokyo, Japan), respectively. The yeast cell count was enumerated via spread plating on potato dextrose agar (PDA; Oxoid, Hampshire, United Kingdom).

Sugars, glycerol, organic acids, amino acids and isoflavones were analyzed and quantified using high performance liquid chromatography (HPLC; Shimadzu, Kyoto, Japan). Both sugars and glycerol were separated using a Zorbax carbohydrate column (150×4.6 mm; Agilent, Santa Clara, Calif., USA) connected to evaporative light scattering detector (ELSD). Sugars were eluted at 40° C. with acetonitrile/water (80:20 v/v) as mobile phase flowing at 1.4 mL/min. Glycerol was eluted using the same mobile phase at 30° C. and flow rate of 0.5 mL/min. Organic acids were separated using Supelcogel C-160 H column (300×7.8 mm; Supelco, Bellefonte, Pa., USA) with 0.1% (v/v) sulfuric acid (H₂SO₄) as the mobile phase at 0.4 mL/min and column temperature of 40° C. Organic acid were identified using photodiode array (PDA) set at 210 nm as the detector.

Amino acids and ammonia content were analyzed by using reversed-phase Waters AccQ-Tag Nova-Pak C18 column (150×3.9 mm; Waters, Dublin, Ireland) and reagents from Waters. Isoflavones were analysed using Zorbax Eclipse Plus C18 Column (150×4.6 mm; Agilent, Santa Clara, Calif., USA) with 0.1% acetic acid in DI water (solvent A) and 0.1% acetic acid in methanol (solvent B). The analysis started with 15% solvent B with gradual increments of solvent B till 50% within 46 minutes and held at 50% solvent B for additional 10 minutes before equilibrating back to 15% solvent B. Isoflavones were detected and identified using PDA set at 262 nm. All analytes were identified and quantified using analytical grade sugars, glycerol, organic acids, amino acids and isoflavones as standards.

Soluble protein determination was carried using the Bradford method (Bradford, 1976) and the Bradford protein assay kit was purchased from Bio-Rad (California, United States of America). Five mL of the diluted protein reagent was added to 0.1 mL of the sample/BSA standard and incubated for five minutes before absorbance measurement at 595 nm using a UV-Vis spectrophotometer (UVmini-1240, Shimadzu, Kyoto, Japan).

Antioxidant capacity of the alcoholic beverage was determined using 2,2-diphenyl-1-picrylhydrazyl (DPPH) analysis. Pre-treated samples and Trolox standards (0.1 mL) were mixed with 3.9 mL of 25 mg/L methanolic DPPH solution and left to stand in the dark for two hours. The analysis was carried out using a UV-Vis spectrophotometer (UVmini-1240, Shimadzu, Kyoto, Japan) set at 515 nm.

Volatile components were determined using headspace solid-phase micro-extraction (HS-SPME) gas chromatography (GC) coupled with mass spectrometry (MS) and flame ionization detector (FID) (Agilent; Santa Clara, Calif., USA). The samples were adjusted to pH 2.5 using 1M hydrochloric acid and then subjected to HS-SPME extraction at 60° C. for 50 minutes using a carboxen/poly(dimethylsiloxane) fiber (Supelco, Bellefonte, Pa., USA) at 250 rpm/min. The SPME fiber was desorbed at 250° C. for 3 minutes in the injection port. Helium (carrier gas) flow rate was set at 1.2 mL/min and the temperature program was set to increase from 50° C. (5 minutes) to 230° C. (30 minutes) at a rate of 5° C./min. Identification of the volatile compounds was done by comparing their individual mass spectra with the NIST08 Library and Wiley275 Library as well as linear retention indices (LRI). Ethanol quantification was performed using external standards dissolved in 10% (v/v) unfermented soy whey.

Phytate analysis were carried out by first adjusting the samples to pH 2.0-2.5 using 0.8 M HCl, followed by the addition of 10% (w/v) NaCl to the acidified samples. The samples were shake at 250 rpm for 30 minutes before putting into a 4° C. refrigerator for 60 minutes to allow the sediments to settle. The samples were then centrifuged at 14000 g for 5 minutes and the supernatant was diluted by a factor of 25 and 250 μL of the diluted samples were mixed with 83.3 μL of the modified Wade reagent (0.3 g FeCl₃.6H₂O with 3 g 5′-sulphosalicyclic acid in 1 litre of DI water). Absorbance of the coloured samples were measured at 500 nm using a microplate reader and the concentrations of the phytate in the samples were determined using a standard calibration curve (expressed in mg PA-P/L).

### Example 1—Effect of Different S. cerevisiae Yeast on Beverage Formed

Four different species of commercial Saccharomyces (S.) cerevisiae yeasts were used in the example. The species were S. cerevisiae Merit, S. cerevisiae EC1118, S. cerevisiae R2, and S. cerevisiae 71B.

The different strains of yeasts were inoculated at 1% (v/v) ratio into the soy whey and fermented for 10 days at 20° C. Samples were withdrawn periodically for analysis.

### Yeast Viability

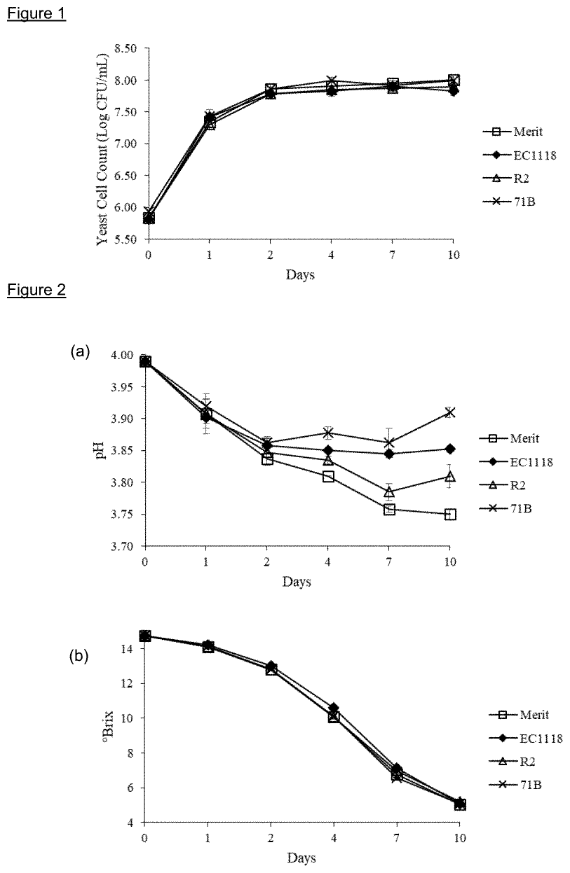

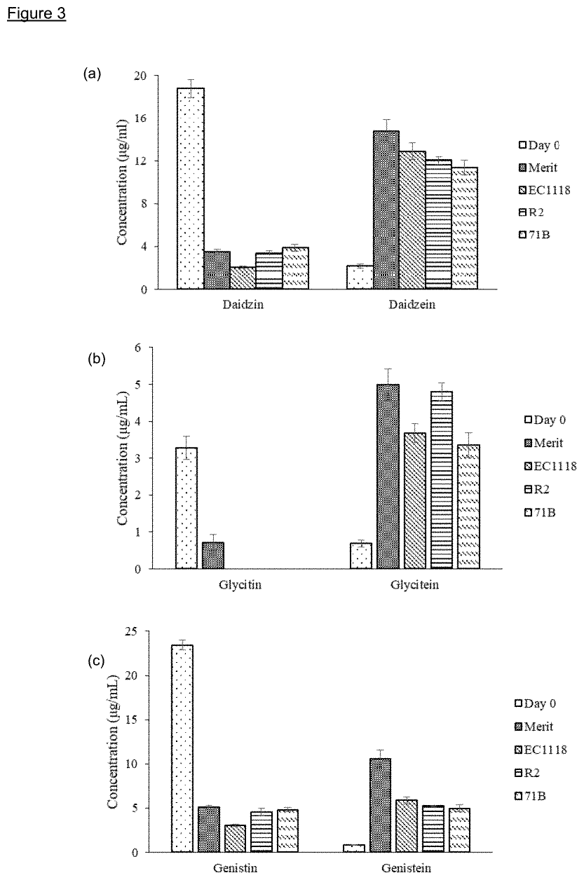

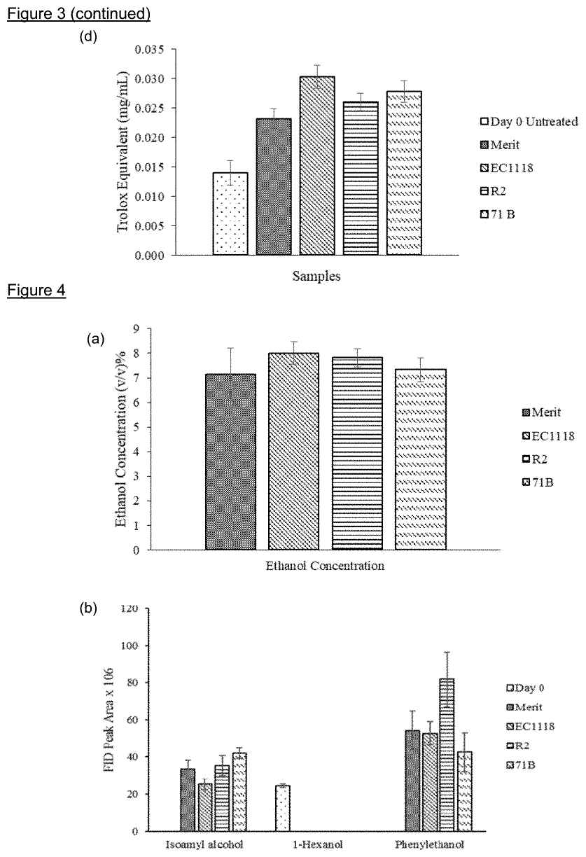

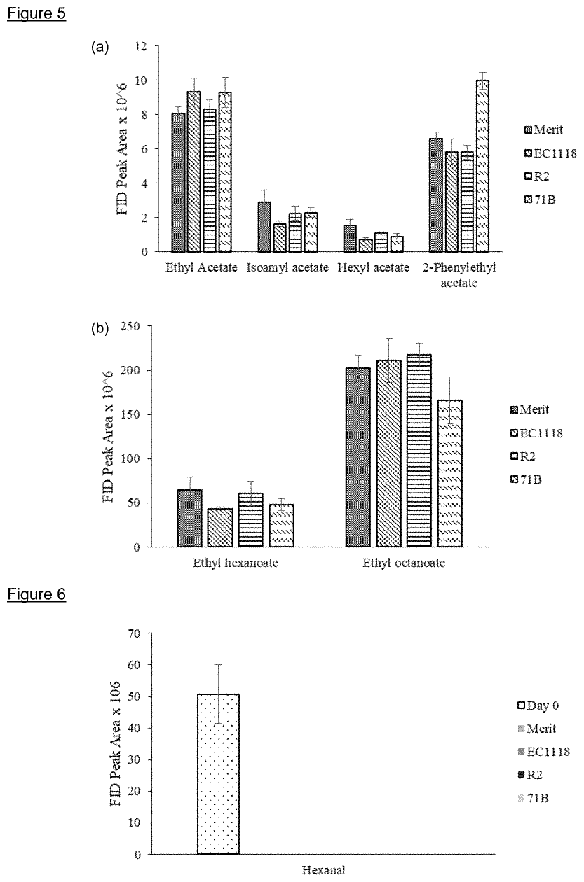

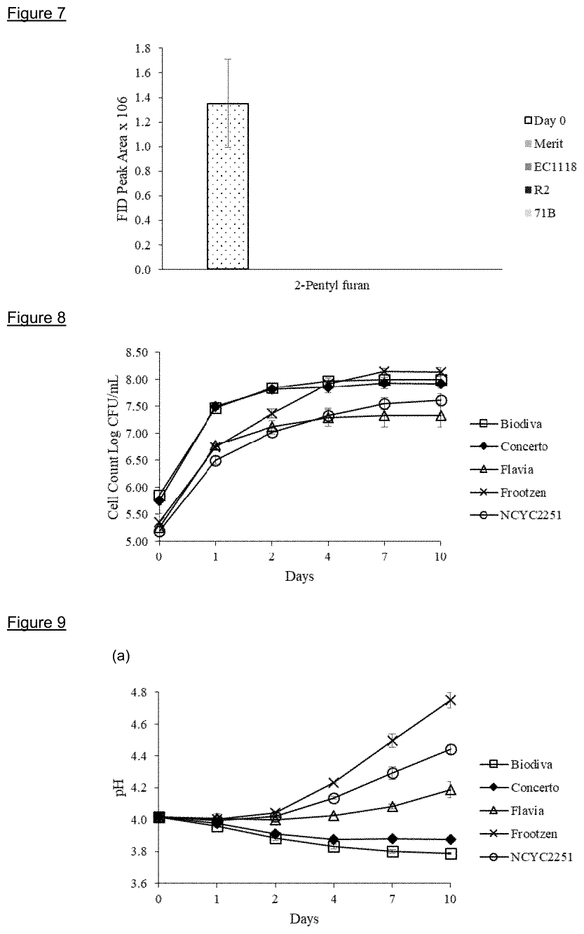

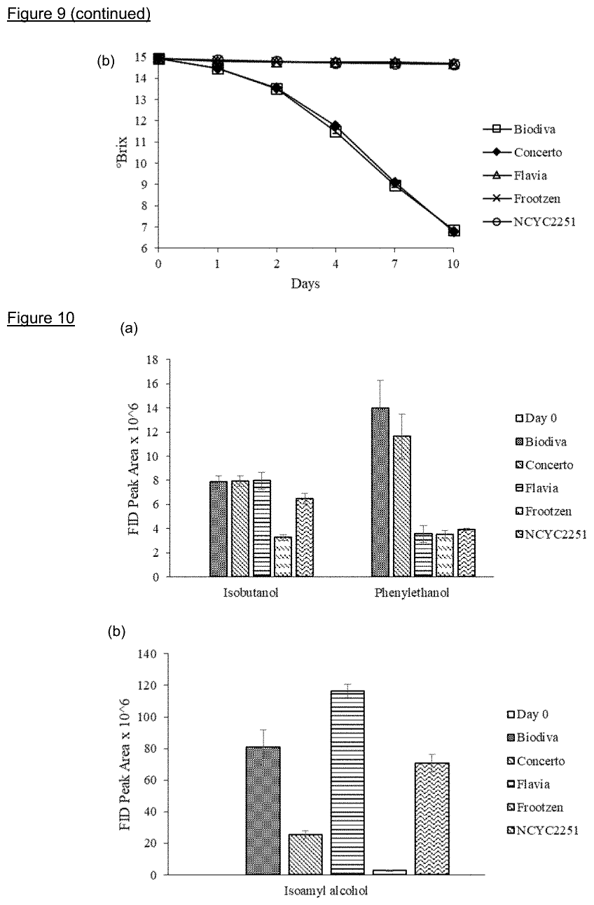

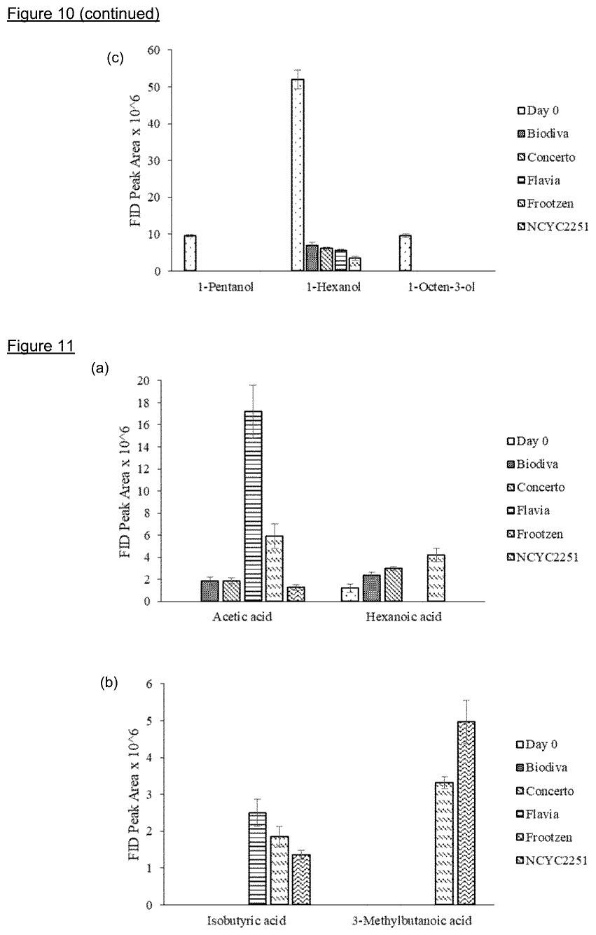

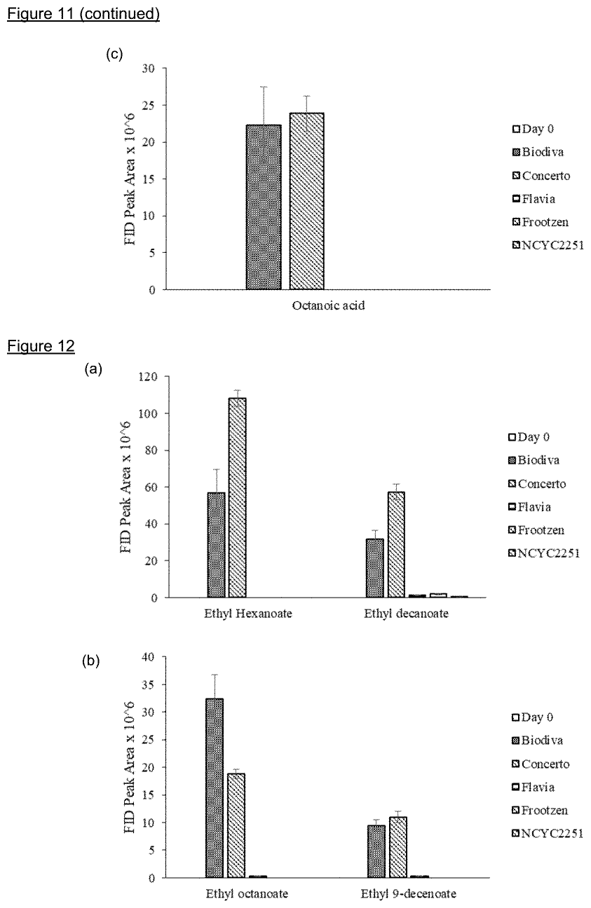

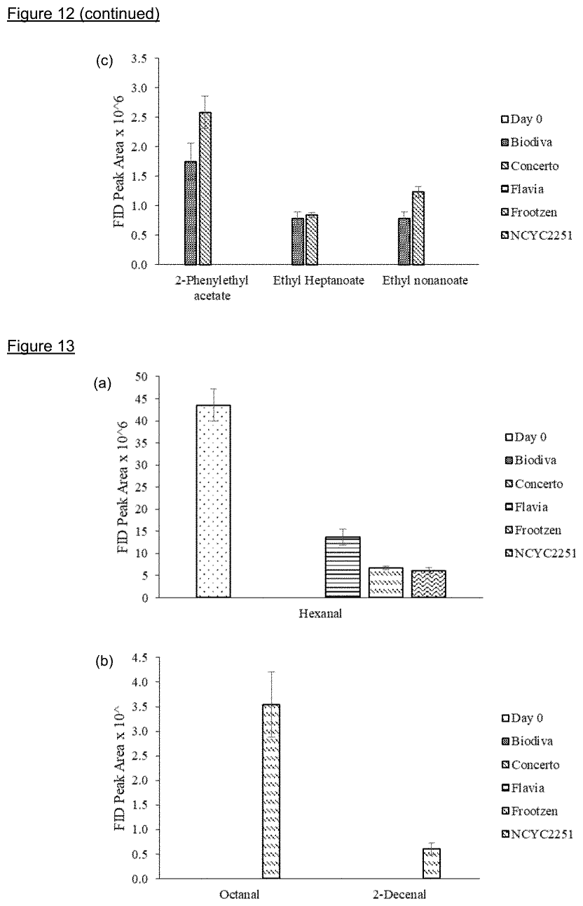

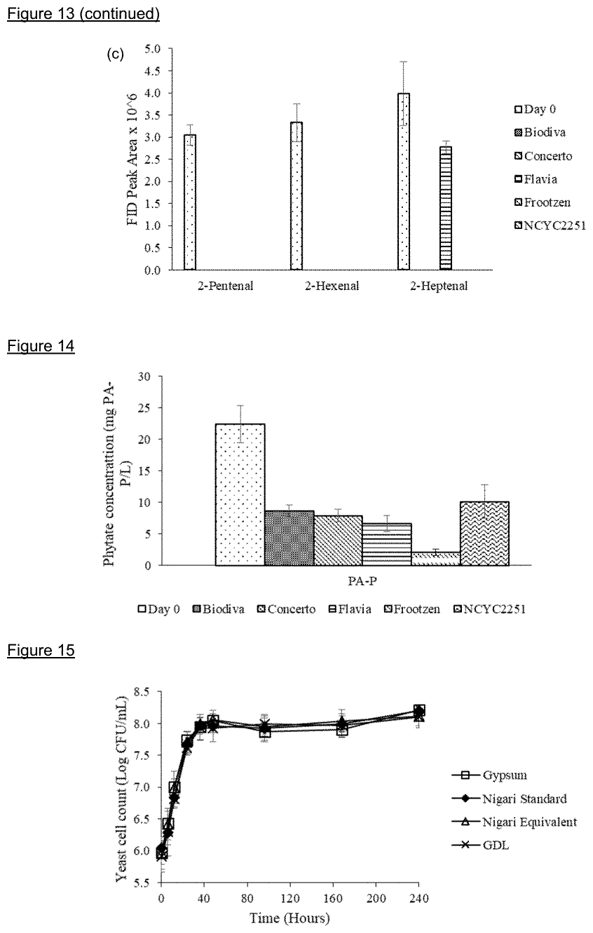

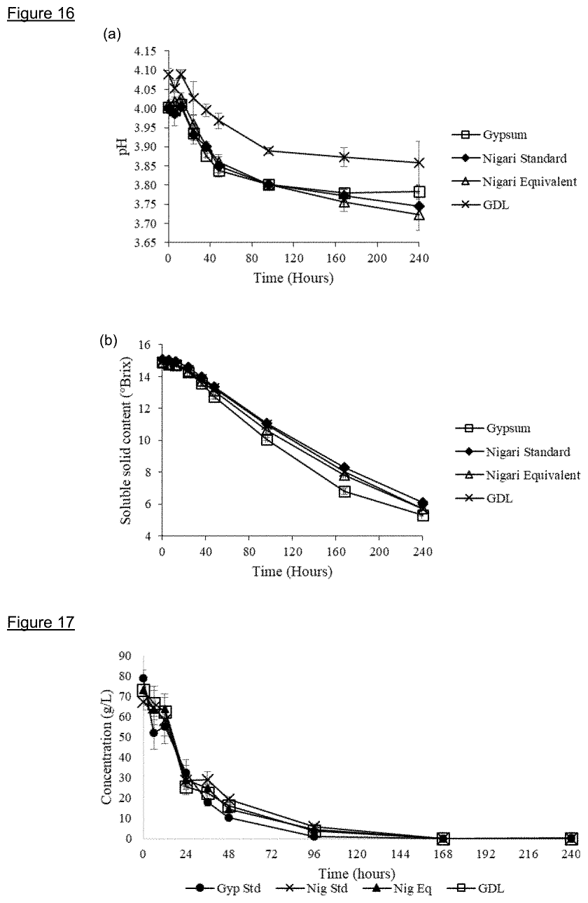

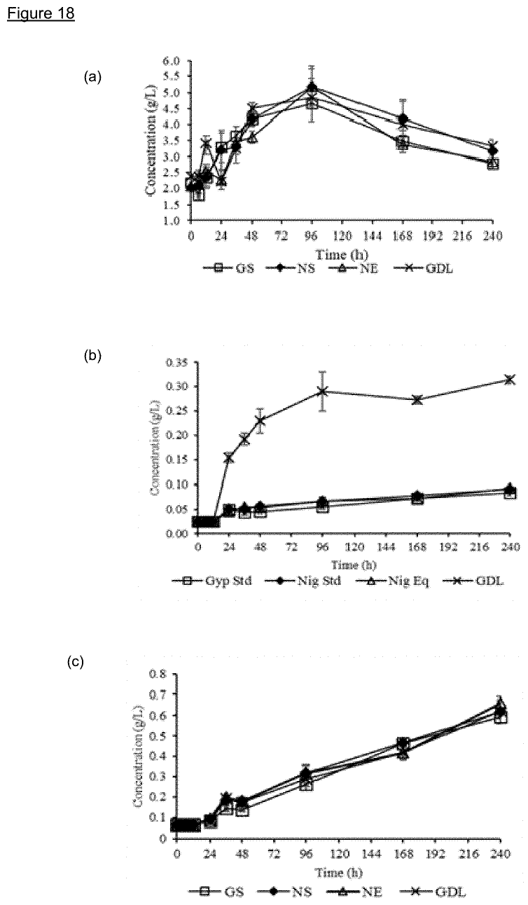

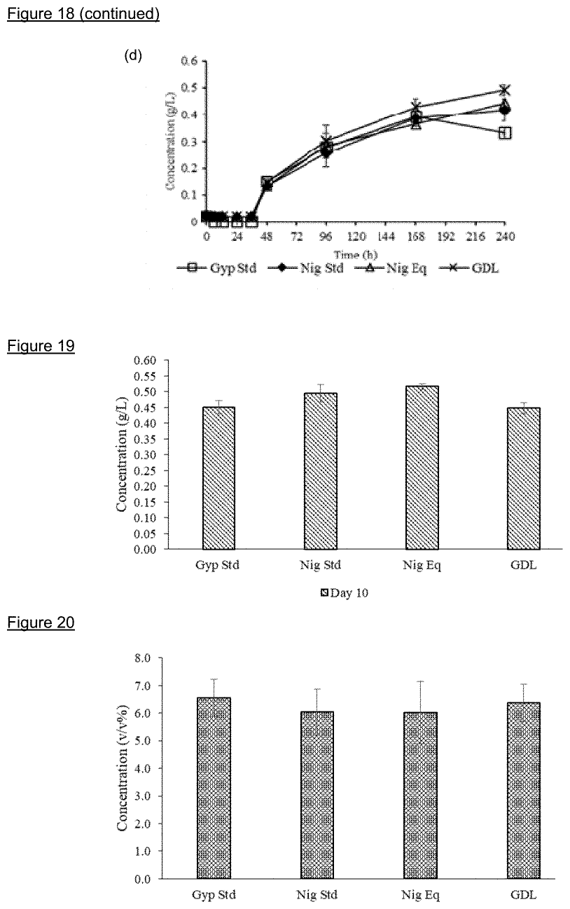

FIG. 1 shows the yeast viability of all four Saccharomyces yeasts used in this example. All the yeasts used showed growth and remained viable till the end of the fermentation in the soy whey medium. This shows that the soy whey contained sufficient nutrient for the growth of the yeast.

### pH and Soluble Solid Content

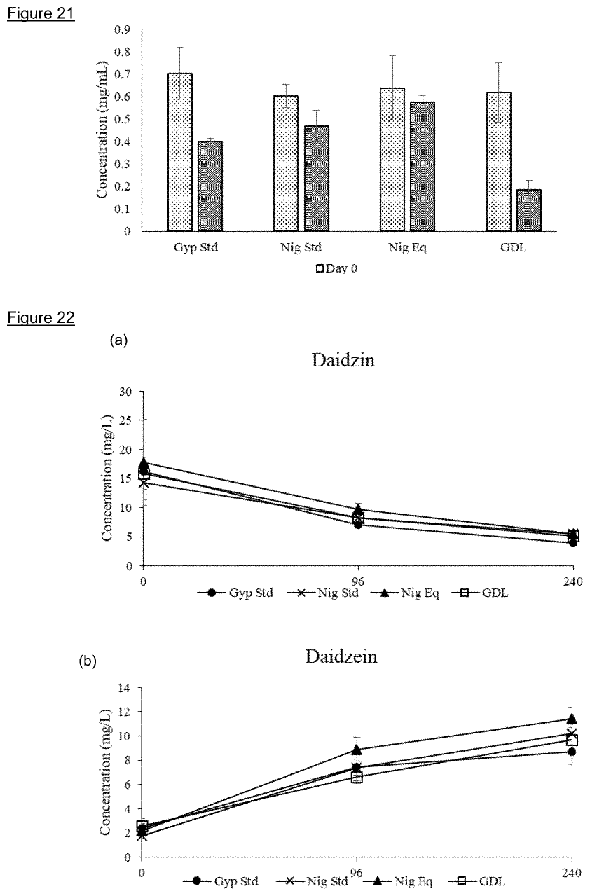

FIG. 2(a) shows the pH of the beverage, i.e. soy wine over the course of the fermentation and FIG. 2(b) shows the soluble solid content changes during the fermentation.

As can be seen in FIG. 2(a), all four Saccharomyces yeasts were able to further acidify the soy wine beverage, with Merit strain producing the most acidic wine at the end of the fermentation. The higher the acidity, the more sour the alcoholic beverage will be. The four Saccharomyces yeasts shared similar Brix profiles throughout the fermentation as can be seen in FIG. 2(b). The decrease in the Brix value means that the yeasts were able to utilize the nutrients in the soy whey which is consistent with the results as shown in Table 1.

### Changes in Sugar, Glycerol and Organic Acids

Table 1 shows the properties of the beverages formed using the different strains of yeast.

TABLE 1
Enological parameters of the spy whey and the respective soy whey
wine formed from the different monoculture S. cerevisiae

| | Day 0 | | | | |
|---|---|---|---|---|---|
| | Pre-treated | Soy whey wine | | | |
| | soy whey | Merit | EC1118 | R2 | 71B |
| pH | 3.99 ± 0.01a | 3.75 ± 0.01b | 3.85 ± 0.00c | 3.81 ± 0.02d | 3.91 ± 0.01e |
| ° Brix | 14.77 ± 0.03a | 5.04 ± 0.06b | 5.10 ± 0.03bc | 5.20 ± 0.09c | 5.09 ± 0.07bc |
| Ethanol (% v/v) | 0.00 ± 0.00a | 7.15 ± 1.06b | 8.00 ± 0.45b | 7.82 ± 0.38b | 7.33 ± 0.48b |
| Total Sugars | 12.754 ± 0.106a | 0.371 ± 0.072bc | 0.523 ± 0.065cd | 0.605 ± 0.062d | 0.340 ± 0.045b |
| (g/100 mL) | | | | | |
| Total Organic Acid | 0.455 ± 0.040a | 0.772 ± 0.047b | 0.705 ± 0.027b | 0.739 ± 0.053b | 0.704 ± 0.012b |
| (g/100 mL) | | | | | |

It can be seen from Table 1 that the sugars present in the soy whey were metabolized to low levels at the end of the fermentation which demonstrated that the yeasts were able to use the supplemented sucrose for growth. The decrease in the amount of sugars corresponded with the increase in the ethanol content of the soy wine formed following the fermentation. The four Saccharomyces yeasts produced glycerol during the fermentation. Glycerol production is essential to wine production as it impart mild sweetness, smoothness and viscosity to the wine.

### Changes in Soluble Protein and Amino Acids

As shown in Table 2, a substantial amount of soluble protein content was observed in the soy whey prior to fermentation. A decrease in the final concentration of the soluble protein was observed for all the samples at the end of the fermentation. It is known that S. cerevisiae yeasts possess proteolytic activity. The conversion of the protein to amino acids is beneficial for the yeast growth. The different types of amino acids shown in Table 2 generally showed a decrease in the concentration at the end of the fermentation with few exceptions. The utilization of the amino acids is essential for the growth of the yeasts.

TABLE 2
Concentration of the total soluble protein content and amino
acid content on Day 0 and Day 10 of the fermentation

| | Day 0 | | | | |
|---|---|---|---|---|---|
| | Pre-treated | Day 10 | | | |
| | soy whey | Merit | EC118 | R2 | 71B |
| Soluble protein | 1.041 ± 0.039a | 0.803 ± 0.061b | 0.490 ± 0.083c | 0.597 ± 0.043cd | 0.681 ± 0.020d |
| (mg/mL) | | | | | |
| Total amino | 18.737 ± 1.823a | 2.730 ± 0.266b | 2.314 ± 0.136b | 2.593 ± 0.191b | 2.286 ± 0.264b |
| acid | | | | | |
| (mg/100 mL) | | | | | |

### Changes in Isoflavone Content and Antioxidant Capacity

FIG. 3 shows the changes in isoflavone glucoside and free isoflavone concentrations in the pre-treated soy whey and at the end of the fermentation of the soy whey. Soy isoflavones are naturally present in abundant amount in soybeans. These isoflavones, in both the glycosides and the aglycones (free) form, may remain soluble after coagulation of soybean and migrate to the soy whey. All isoflavone glycosides (i.e. isoflavone bound to sugars, examples being daidzin, glycitin, genistin) decreased in concentration while all the free isoflavones (aglycones) such as daidzein, glycitein and genistein, increased in concentration at the end of the fermentation as reflected in FIG. 3. The increase in isoflavone aglycone is beneficial as it enhances the absorption of the isoflavone in the gastrointestinal tract when consumed.

### Changes in Volatile Profile

Wth the sugar supplementation prior to the fermentation, the ethanol content of the soy wine ranged between 7-8%. Indigenous undesirable off-flavour imparting hexanol present in the soy whey was undetectable while new alcohols were produced. The disappearance of the indigenous alcohols improves soy whey flavour through reducing the grassy and beany off-flavour characteristic of the soy product. The results are as shown in FIG. 4.

FIG. 5 shows the changes in the ester content after fermentation. No esters were detected in the original soy whey. Esters were only detected in the soy wine after fermentation. The formation of esters by the yeasts is beneficial as esters impart fruity and floral characteristic to the final product and this can help to mask the beany and grassy odour originally present in the soy whey.

FIG. 6 shows the changes in the aldehyde content before and after fermentation. It can be seen that endogenous aldehydes, particularly hexanal, were metabolized to undetectable levels after the fermentation. This may be beneficial to the aroma profile of the soy wine as the disappearance of the aldehydes will reduce the beany and grassy odour of the soy whey.

FIG. 7 provides the changes in 2-pentylfuran content before and after fermentation. It can be seen that following fermentation, 2-pentylfuran is not present in any of the samples. 2-pentylfuran, which has a licorice-like flavour on its own, is formed from the breakdown of linoleic acid by the soy lipoxygenase. Together with hexanol, 2-hexenal, ethyl vinyl ketone, 2-pentylfuran can contribute to the grassy and beany odour of soy products. The metabolism of 2-pentylfuran is beneficial to the aroma profile of the soy whey as it reduces the grassy and beany odour of the soy wine.

### Example 2—Effect of Non-Saccharomyces Yeasts on Beverage Formed

Five different species of commercial non-Saccharomyces yeasts (Torulaspora (T.) delbrueckii Biodiva, Kluyveromyces (K.) thermotolerans Concerto, Metschnikowia (M.) puicherrima Flavia, Pichia (P.) Kluyveri, Frootzen and Williopsis (W.) saturnus NCYC2251) were used in the experiment. Different strains of yeasts were inoculated 1% (v/v) ratio into the soy whey and fermented for 10 days at 20° C. Samples were withdrawn periodically for analysis.

Similar analysis as carried out in Example 1 was carried out in this example.

### Yeast Viability

It can be seen from FIG. 8 that all five yeasts were able to grow in the soy whey and experience a 2-2.5 log CFU/mL growth at the end of the fermentation. This shows that the soy whey comprised sufficient nutrients for the growth of non-Saccharomyces yeasts.

### pH and Soluble Solid Content

FIG. 9(a) shows the pH of the beverage, i.e. soy wine over the course of the fermentation and FIG. 9(b) shows the soluble solid content changes during the fermentation.

As can be seen in FIG. 9, two distinct trends can be observed from FIG. 9(a). Biodiva and Concerto experienced a slight drop in pH while the other three yeasts experienced an increase in the pH. The increase in pH shows that the alcoholic beverage for the latter three yeasts will be less sour as compared to the alcoholic beverage fermented from Biodiva and Concerto. As for the soluble solid content, Biodiva and Concerto experienced a continuous decrease in the ° Brix value while the other three yeasts had a constant ° Brix value. This shows that Flavia, Frootzen and NCYC2251 were unable to significantly utilize the supplemented sucrose for growth.

### Changes in Sugar, Glycerol, Ethanol and Organic Acids

Table 3 shows the properties of the beverages formed using the different strains of yeast.

TABLE 3
Enological parameters of soy whey and the respective soy wine conducted
by various monocultures of non-Saccharomyces yeasts

| | Day 0 | | | | | |
|---|---|---|---|---|---|---|
| | Pre-treated | Day 10 | | | | |
| | soy whey | Biodiva | Concerto | Flavia | Frootzen | NCYC2251 |
| pH | 4.02 ± 0.01a | 3.79 ± 0.01b | 3.88 ± 0.02c | 4.19 ± 0.05d | 4.75 ± 0.05e | 4.44 ± 0.03f |
| °Brix | 14.94 ± 0.08a | 6.84 ± 0.08b | 6.78 ± 0.11b | 14.71 ± 0.04c | 14.68 ± 0.07c | 14.68 ± 0.03c |
| Ethanol content (v/v %) | 0.00 ± 0.000a | 7.12 ± 0.60b | 6.20 ± 1.03b | 0.00 ± 0.00a | 0.00 ± 0.00a | 0.00 ± 0.00a |
| Total sugars (g/L) | 112.60 ± 11.91a | 22.57 ± 1.11b | 23.50 ± 1.12b | 99.97 ± 5.46a | 98.08 ± 4.62a | 104.16 ± 8.57a |
| Glycerol (g/L) | 0.00 ± 0.000a | 4.18 ± 0.18b | 3.42 ± 0.09c | 0.00 ± 0.00a | 0.00 ± 0.00a | 0.00 ± 0.00a |
| Total organic acids (g/L) | 4.77 ± 0.25ab | 7.27 ± 0.16c | 7.29 ± 0.12c | 5.22 ± 0.08b | 3.99 ± 0.23d | 4.58 ± 0.37a |

Sugars added to the soy whey prior to the fermentation were metabolized to a large extent in Biodiva and Concerto samples, while insignificant changes to the sugar content were observed in the other three yeasts samples. This observation shows that Flavia, Frootzen and NCYC2251 were not able to metabolize the added sugars in the soy whey. The extent of sugar utilization corresponded to the amount of ethanol produced, with Biodiva and Concerto producing between 6-7% of ethanol while no ethanol was detected in the other three yeasts samples (not suitable for alcoholic beverage production). Glycerol was only detected in Biodiva and Concerto samples and glycerol is known to contribute to smoothness and viscosity of the product

For organic acid production, Biodiva and Concerto showed significant increases in the organic acid content which corresponded to the decrease in pH. Frootzen showed a significant decrease in the organic acid content which corresponded to the greatest increase in the pH at the end of the fermentation. The increase in organic acid content in Biodiva and Concerto samples is beneficial in creating a hurdle for the growth of spoilage microorganism that will affect the shelf life of the product.

### Changes in Soluble Protein, Amino Acids and Gamma Amino-Butyric Acid Content

The five non-Saccharomyces yeasts used in this example had differing levels of protein utilization, with Flavia having the highest protein utilization at the end of the fermentation. The results are as shown in Table 4.

High protein utilization shows that Flavia has a high proteolytic activity to convert protein to amino acids for growth. The five yeasts also showed differing levels of amino acid utilization, with Biodiva and Concerto having the lowest amino acid content at the end of the fermentation. High amino acid utilization supports both the yeast growth and flavour production. Gamma amino-butyric acid (GABA) is commonly found in legumes and was detected in the soy whey. Biodiva, Concerto and NCYC2251 utilized the GABA for their metabolism while Flavia and Frootzen did not utilize the GABA. GABA is a bioactive compound that can act as an anti-hypertensive agent and can serve as a functional ingredient in the product.

TABLE 4
Concentration of the soluble protein and amino acid content of the soy whey before and after fermentation

| | Day 0 | | | | | |
|---|---|---|---|---|---|---|
| | Pre-treated | Day 10 | | | | |
| | soy whey | Biodiva | Concerto | Flavia | Frootzen | NCYC2251 |
| Soluble protein (g/L) | 1.33 ± 0.08a | 0.65 ± 0.04b | 0.38 ± 0.07c | 0.09 ± 0.01d | 0.45 ± 0.02ce | 0.56 ± 0.05be |
| Total amino acid (mg/L) | 197.79 ± 21.27a | 23.12 ± 2.39b | 21.98 ± 1.33b | 94.65 ± 2.54c | 59.04 ± 7.81d | 58.87 ± 7.01d |
| GABA (mg/L) | 26.82 ± 3.43a | 5.58 ± 0.94b | 5.45 ± 1.04b | 27.74 ± 0.97a | 26.56 ± 2.12a | 16.53 ± 2.25c |

### Changes in Isoflavone Content and Antioxidant Capacity

Isoflavones, both the aglycones and glucosides, were detected in the soy whey prior to fermentation. The five yeasts showed differing levels of hydrolysis, with NCYC2251 having the highest β-glucosidase activity. The increase in isoflavone aglycone concentration after the fermentation resulted in an increase in the antioxidant capacity of the respective wine. Hence, the conversion of isoflavone glucoside to isoflavone aglycone is beneficial in increasing the health benefit of the resulting alcoholic beverage. The results of the analysis are as shown in Table 5.

### Changes in Volatile Profile

The changes in the alcohol content before and after fermentation is shown in FIGS. 10 (a) to (c). In particular, endogenous alcohols such as 1-pentanol, 1-hexanol and 1-octen-3-ol were metabolized to low or trace levels at the end of the fermentation by the five yeasts. The reduction of indigenous alcohol is beneficial in reducing the beany and grassy odour of the alcoholic beverage. New alcohols, such as ethanol (refer to Table 3), isobutanol, phenylethanol and isoamyl alcohol were produced by the five yeasts that can contribute to the aroma profile of the alcoholic beverage.

FIGS. 11 (a) to (c) show the changes in the volatile acid content of the soy whey before and after fermentation. In particular, hexanoic acid was the only acid detected in the soy whey. New volatile acids were produced by the yeasts and the type of acids produced differed among the yeast strains. The different types of volatile acids produced will affect the aroma profile differently.

FIGS. 12 (a) to (c) on the other hand shows the ester content of the spy whey before and after fermentation. Esters were not detected in the soy whey prior to fermentation. The esters detected in the wine samples were the result of the fermentation process and the esters will impart a fruity character to the alcoholic beverage.

The changes in the aldehyde content of the soy whey before and after fermentation is shown in FIGS. 13 (a) to (c). Indigenous aldehydes such as hexanal, 2-pentenal, 2-hexenal and 2-heptenal were detected in the soy whey prior to the fermentation and these aldehydes were metabolized to low or trace levels at the end of the fermentation. The metabolism of these indigenous aldehydes is beneficial as the grassy and beany odour of the soy whey will be reduced. New aldehydes such as octanal and 2-decenal were detected in Frootzen samples that can impart aroma profile of the beverage.

### Changes in Phytate Content

Soybeans are known to contain anti-nutrients such as phytate which binds minerals, reducing mineral bioavailability. Phytate had been detected in the soy whey pre-fermentation. However, the phytate concentration decreased in all the samples after the fermentation. This is therefore advantageous.

TABLE 5
Changes to the isoflavone content and antioxidant capacity of the soy whey before and
after fermentationExample 3 - Effect of coagulant in soy whey on beverage formed

| | Day 0 | Day 10 | | | | |
|---|---|---|---|---|---|---|
| Isoflavones (mg/L) | Pre-Treated Soy Whey | Biodiva | Concerto | Flavia | Frootzen | NCYC2251 |
| Daidzin | 17.66 ± 0.72 | 5.30 ± 0.26 | 7.35 ± 0.64 | 16.14 ± 1.73 | 11.62 ± 1.76 | 0.61 ± 0.06 |
| Glycitin | 3.77 ± 0.19 | 0.34 ± 0.03 | 0.35 ± 0.03 | 0.16 ± 0.04 | 0.19 ± 0.02b | 0.13 ± 0.02 |
| Genistin | 25.99 ± 1.28 | 6.37 ± 0.58 | 9.16 ± 0.38 | 20.93 ± 2.24 | 14.62 ± 0.99 | 0.71 ± 0.06 |
| Total glucosides | 47.42 ± 2.07 | 12.01 ± 0.82 | 16.86 ± 0.90 | 37.24 ± 3.99 | 26.42 ± 2.47 | 1.45 ± 0.13 |
| Daidzein | 1.88 ± 0.11 | 11.65 ± 0.94 | 11.67 ± 0.46 | 5.32 ± 0.80 | 8.78 ± 0.48 | 13.12 ± 0.32 |
| Glycitein | 0.38 ± 0.08 | 4.66 ± 0.41 | 5.02 ± 0.22 | 3.66 ± 0.13 | 4.23 ± 0.24 | 4.40 ± 0.05 |
| Genistein | 1.16 ± 0.08 | 9.27 ± 1.59 | 9.95 ± 0.76 | 3.92 ± 0.58 | 7.98 ± 0.64 | 9.61 ± 1.05 |
| Total alycones | 3.42 ± 0.19 | 25.58 ± 2.93 | 26.64 ± 1.38 | 12.90 ± 1.33 | 20.99 ± 1.27 | 27.13 ± 1.19 |
| Total Isoflavones | 50.84 ± 2.23 | 37.59 ± 3.71 | 43.50 ± 2.16 | 50.14 ± 2.87 | 47.41 ± 2.52 | 28.58 ± 1.26 |
| Trolox equivalent* (mg/mL) | 0.023 ± 0.002 | 0.014 ± 0.001 | 0.023 ± 0.001 | 0.022 ± 0.001 | 0.024 ± 0.000 | 0.020 ± 0.001 |

In this example, the soy whey produced by the method described above was used. In addition to this, other soy wheys were also used in which a different coagulant was used. In particular, the method of making the soy whey was the same, except that the coagulant used in making the initial soybean was different.

Accordingly, soybean was made using three commercially available coagulants (gypsum, glucono-delta-lactone and nigari) using the method explained above (Soybean curd whey production) and the respective soy whey generated was used for fermentation using T. delbrueckii Biodiva for 10 days at 20° C. Samples were withdrawn periodically for analysis.

### Yeast Viability

As can be seen from FIG. 15, the yeast grew well in the tofu whey regardless of the coagulant used and the yeast grew by approximately 2 log CFU/mL by the end of the fermentation period. This shows that the presence of different coagulants (or ions) do not affect the growth of the yeast.

### pH and Soluble Solid Content

FIG. 16(a) shows the pH of the beverage, i.e. soy wine over the course of the fermentation and FIG. 16(b) shows the soluble solid content changes during the fermentation.

As can be seen in FIG. 16, all the samples experienced a decrease in the pH by the end of the fermentation period. The soluble solid content for the four samples experienced a continuous decrease in the ° Brix value throughout the fermentation. This shows that the different coagulants did not affect the acid production and sugar utilization.

### Changes in Sugar, Glycerol, Ethanol and Organic Acids

The changes in the sucrose content during fermentation is shown in FIG. 17 while FIGS. 18(a) to (d) show the changes to the organic acid content. It can be seen that the yeasts were able to utilize the fermentable sugars in the respective soy whey. The presence of higher calcium in the gypsum soy whey may have contributed to the slightly faster sucrose utilization as shown in FIG. 17(a).

The presence of the different coagulants also did not affect the production and metabolism of malic acid, succinic acid and pyruvic acid as can be seen from FIGS. 18(a), (c) and (d).

However, the presence of GDL significantly increased the production of alpha-ketoglutaric acid during the fermentation, as shown in FIG. 18(b). Accordingly, the presence of GDL has impact on the physiological function of the yeast to induce higher alpha-ketoglutaric acid production.

Glycerol content present in the respective soy whey beverage is shown in FIG. 19. The presence of magnesium ions in the Nigari samples (both nigari standard and nigari equivalent) produced slightly more glycerol than the gypsum and GDL samples. The higher glycerol content may provide more mouthfeel and viscosity to the alcoholic beverage fermented with nigari soy whey.

Ethanol content present in the respective soy when beverage is shown in FIG. 20. It can be seen that the presence of different coagulants did not affect the ethanol production across the different samples. However, it is interesting to note that nigari samples have slightly, but insignificantly, lower alcohol content but higher glycerol content.

### Changes in Soluble Protein Content

As can be seen from FIG. 21, the soluble protein content in all the samples dropped after the fermentation. The presence of GDL induced higher protein utilization while the presence of nigari induced lower protein utilization. Higher protein utilization indicates higher amino acids production which can aid in yeast growth and flavour production.

### Changes in Isoflavone Content and Antioxidant Activity

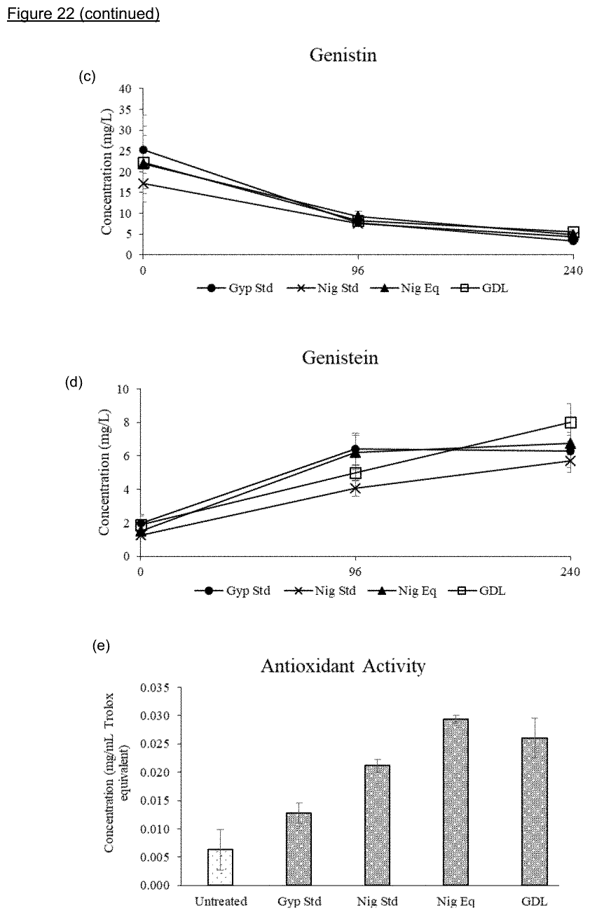

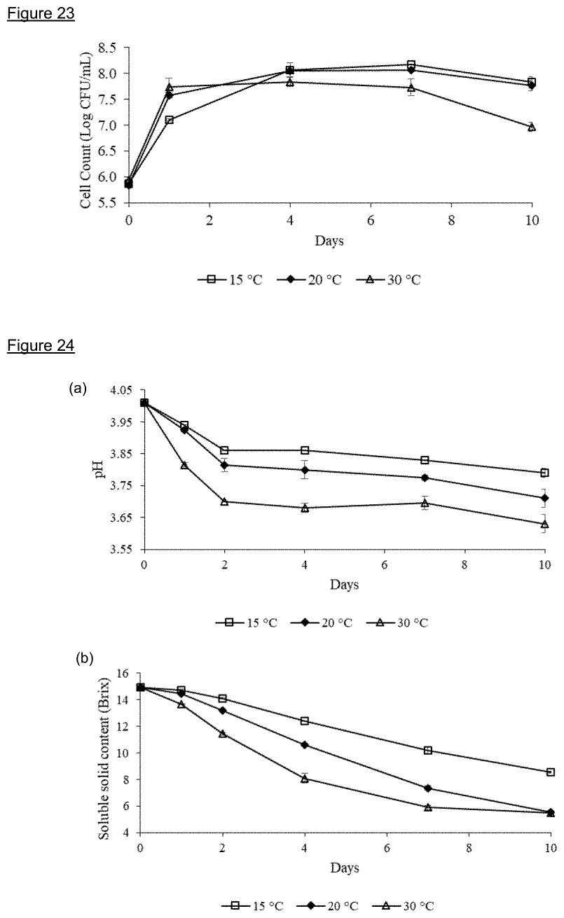

FIG. 22 shows the changes in the isoflavone content. Isoflavone glucosides (daidzin and genistin) concentration decreased and isoflavone aglycones increased in concentration after fermentation, indicating that the yeasts were able to hydrolyze the glucosides to their corresponding aglycone. The increase in aglycone concentration resulted in an increase in the antioxidant capacity as shown in FIG. 23(e).

### Example 4—Effect of Temperature on Soy Whey Wine Fermentation

In this example, the effect of temperature on the fermentation kinetics of wine yeast Torulaspora delbrueckii Biodiva in tofu whey wine fermentation was evaluated.

The fermentation method described above was used except that for each sample, the fermentation temperature was adjusted to 15° C., 20° C. and 30° C. The fermentation was carried out for 10 days with the soy whey having a starting sugar content of 15° Brix.

FIG. 23 shows the cell count of yeast over the course of fermentation. As can be seen from the figure, the yeasts were able to grow and survive in the soy whey under different fermentation temperature albeit minor differences. The yeast in the 15° C. samples grew at a slower rate during the first two days while the yeast in the 30° C. samples experience a drop in the cell count after day 4. The high temperature (30° C.), combined with other factors such as alcohol, could have accelerated the cell death in the tofu whey wine samples.

FIGS. 24(a) and (b) shows the pH changes and the changes in the soluble solid content over the course of the fermentation. A distinct trend was observed from the pH and soluble solid content. Wth increasing fermentation temperature, the drop in pH was greater and the decrease in the soluble solid content, which corresponds to sugar consumption, was faster. Higher fermentation temperature induces the yeast to have higher metabolic activity which in turn promoted faster sugar consumption and higher acid production.

Other properties of the resulting soy whey wine after fermentation is provided in Table 6.

TABLE 6
Specific gravity and alcohol content of the
resulting soy whey wine after fermentation

| | | Specific | | Alcohol content | Alcohol content |
|---|---|---|---|---|---|
| Sample | | Gravity | Brix | (1) | (2) |
| Unfermented | | 1.0629 | 14.915 | N.A | N.A |
| Fermented | 15° C. | 1.0146 | 8.53 | 6.34 | 6.57 |
| | 20° C. | 0.9984 | 5.555 | 8.47 | 8.77 |
| | 30° C. | 0.9998 | 5.48 | 8.29 | 8.58 |
| | | | Formula | (OS-FS)*131.25 | (OS-FS)/7.36 |

N.A: Not applicable

Ethanol content in the soy whey wine samples were calculated based on the specific gravity of the samples using two different formulas. The incomplete sugar utilization in 15° C. samples (indicated by the high ending soluble solid content at Day 10) resulted in a lower ethanol content as compared to 20° C. and 30° C. samples.

### Example 5—Effect of Different Sugar Concentration on Soy Whey Fermentation

In this example, the effect of different sugar concentration on the fermentation kinetics in soy whey wine fermentation was evaluated.

The soy whey production method described above was used except that for each sample, the starting sugar content of the soy whey was adjusted to 5, 15, 25 and 30° Brix. The fermentation was carried out for 18 days at 20° C. and the yeast used for the fermentation was Torulaspora delbrueckii Biodiva.

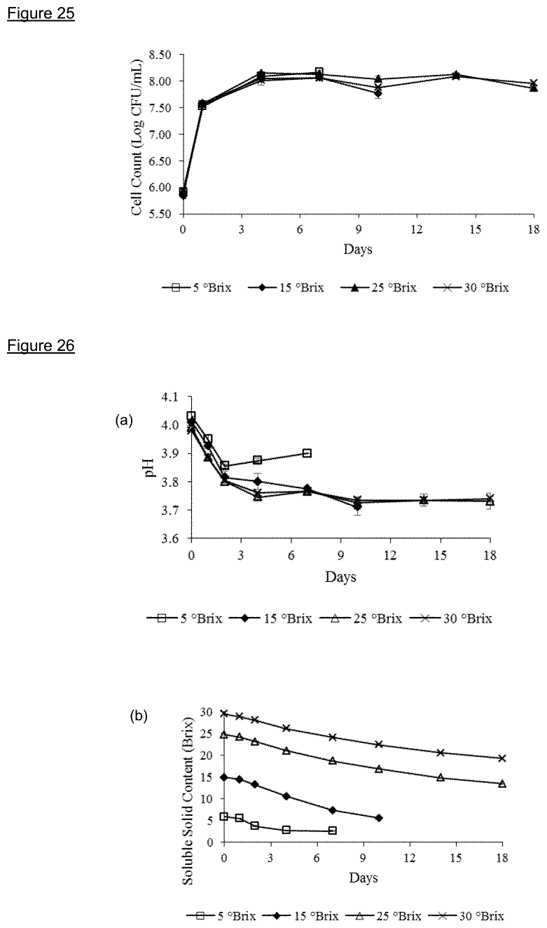

FIG. 25 shows the effect on the yeast. As seen in FIG. 25, the different sugar concentration did not have an impact on the growth of the yeasts. The yeast grew from day 0 to day 4 and remained fairly constant till the end of the fermentation period.

FIGS. 26 (a) and (b) shows the pH changes and the changes in the soluble solid content over the course of the fermentation. All the samples experienced a drop in the pH after the fermentation. The soluble solid content for all samples experienced a drop throughout the fermentation. The samples with the higher starting sugar concentration (25 and 30° Brix) still contained significant amount of sugars even after 18 days of fermentation. This indicates that the fermentation duration will need to be increase for these two set of samples in order for the yeasts to metabolise the sugar to a larger extent. Another solution to speed up sugar utilization is to use another wine yeast (such as Saccharomyces cerevisiae) to ferment these soy wheys that have higher starting sugar concentration.

Other properties of the resulting soy whey wine after fermentation is provided in Table 7.

TABLE 7
Specific gravity and alcohol content of the
resulting soy whey wine after fermentation

| | | Specific | | Alcohol content | Alcohol content |
|---|---|---|---|---|---|
| Sample | | Gravity | Brix | (1) | (2) |
| Unfermented | 5°Brix | 1.0235 | 5.905 | N.A | N.A |
| | 15°Brix | 1.0629 | 14.915 | | |
| | 25°Brix | 1.1041 | 24.76 | | |
| | 30°Brix | 1.128 | 29.52 | | |
| Fermented | 5°Brix | 1.0034 | 2.625 | 2.64 | 2.73 |
| | 15°Brix | 0.9984 | 5.555 | 8.47 | 8.77 |
| | 25°Brix | 1.0222 | 13.47 | 10.75 | 11.13 |
| | 30°Brix | 1.0486 | 19.33 | 10.42 | 10.79 |

| | | |
|---|---|---|
| Formula | (OS-FS)*131.25 | (OS-FS)*1000/7.36 |

N.A: Not applicable

The ethanol produced was proportional to the drop in the soluble solid content (Brix). The ethanol content for 25 and 30° Brix samples can be further increased if the sugars are utilized to a larger extent.

1. A soy whey-derived beverage comprising ≥10 mg/L free soy isoflavones.

2. The beverage according to claim 1, wherein the beverage is a fermented beverage.

3. The beverage according to claim 1, wherein the beverage has an alcohol content of <0.5% by volume.

4. The beverage according to claim 1, wherein the beverage has an alcohol content of ≥0.5% by volume.

5. The beverage according to claim 4, wherein the beverage has an alcohol content of 5-40% by volume.

6. The beverage according to claim 4, wherein the beverage has a total soy isoflavone content of ≥20.

7. The beverage according to claim 4, wherein the beverage has a pH of 2-6.

8. The beverage according to claim 4, wherein the beverage has a Brix of 3-20° Bx.

9. The beverage according to claim 4, wherein the beverage has an ester content of 5-10 mg/L.

10. The beverage according to claim 4, wherein the beverage is wine.

11. A method of forming a soy whey-derived beverage according to claim 1, the method comprising:
providing soy whey;
adding a microorganism to the soy whey; and
fermenting the soy whey at a pre-determined temperature for a pre-determined period of time to form the beverage.

12. The method according to claim 11, wherein the microorganism is yeast.

13. The method according to claim 12, wherein the yeast is Saccharomyces yeast, non-Saccharomyces yeast, or a combination thereof.

14. The method according to claim 12, wherein the yeast is Saccharomyces (S.) cerevisiae, Torulaspora (T.) delbrueckii, Kluyveromyces (K.) thermotolerans, Metschnikowia (M.) pulcherrima, Pichia (P.) kluyveri, Williopsis (W.) saturnus, or a combination thereof.

15. The method according to claim 11, wherein the pre-determined period of time is 2-21 days.

16. The method according to claim 11, wherein the pre-determined temperature is 13-35° C.

17. The method according to claim 11, further comprising adjusting the pH of the soy whey prior to the adding a microorganism to the soy whey.

18. The method according to claim 17, wherein the adjusting comprises adjusting the pH to 3-5.

19. The method according to claim 11, further comprising adding sugars to the soy whey prior to the adding a microorganism to the soy whey.

20. The method according to claim 11, further comprising heating the soy whey prior to the adding a microorganism to the soy whey.
